(19) United States
(12) Patent Application Publication
(10) Pub. No.: US 2007/0112680 A1
(43) Pub. Date: May 17, 2007

(54) System and method for processing digital media content in a mobile device

(75) Inventors: Sabine van Niekerk, Salzgitter-Lebenstedt (DE); Andreas Schmidt, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Munich (DE)

(21) Appl. No.: 11/271,157

(22) Filed: Nov. 11, 2005

(51) Int. Cl. G06Q 99/00

(52) U.S. Cl. 705/57

(57) ABSTRACT

A method for processing digital media content in a mobile device, wherein the digital media content is protected using digital rights management, wherein a digital rights protection removing unit is assigned to the protected digital media content and which digital rights protection removing unit is used to remove the protection from the protected digital media content. The method includes the steps of receiving a presentation request for presenting stored digital media content, retrieving the digital rights protection removing unit from a memory card of a mobile device or from a User Identity Module unit of a mobile device, verifying that the digital rights protection removing unit allows removal of the protection from the protected digital media content, and removing the protection from the protected digital media content using the digital rights protection removing unit, thereby generating unprotected digital media content for presentation using the mobile device.

### FIELD OF THE INVENTION

The present invention relates to processing digital media content, and more particularly to systems and methods for processing digital media content in a mobile device.

### BACKGROUND OF THE INVENTION

In mobile communication systems such as UMTS well-defined Smart Cards, also called Universal Integrated Circuit Cards (UICCs) are used in addition to mobile phones. Plugged into a mobile phone the UICCs enable a user to use the mobile communication service she has subscribed to. Moreover, operator and user parameters and data can be stored on such Smart Cards. Mobile communication systems allow network operators to define their operator-specific applications on the UICC, which can make use of Card Application Toolkit/UMTS Subscriber Application Toolkit (CAT/USAT), the standardized interface between the Universal Integrated Circuit Cards / UMTS Subscriber Identity Module (UICC/USIM) and the Mobile Equipment (ME), which represents the mobile communication device according to the UMTS communication standard, in order to let the applications make use of specific terminal functionality, e.g. for sending an SMS (Short Message Service) to the communication network and via the communication network to a receiver terminal, playing a tone on the ME or displaying text or an icon on the display of the ME.

With the current USAT mechanisms, it is possible to transfer content like for example multimedia messages, i.e. messages including multimedia data, e.g. messages according to the Multimedia Messages Services (MMS) standard from the ME to the UICC and store these multimedia messages on the USIM, even when these are protected according to a digital rights management mechanism, e.g. according to a Digital Rights Management (DRM) standard, e.g. according to a Digital Rights Management (DRM) standard version 1.0 or version 2.0 of the Open Mobile Alliance (OMA).

However, the current USAT mechanisms do not allow the transfer of digital media content rights associated with the DRM protected digital media content from the ME to the UICC and store it on the USIM.

DRM is a mechanism that enables the consumption by users of protected digital media content by allowing digital media content providers to express permissions for and/or constraints on the digital media content.

An example of a DRM architecture 100 according to the DRM version 2.0 according to the standard of the Open Mobile Alliance (OMA) is shown in FIG. 1.

According to the DRM architecture 100, there is provided a content issuer 101, a rights issuer 102 and a DRM agent 103. The DRM agent 103 is connected to the content issuer 101 as well as to the rights issuer 102. Before digital media content is delivered to one user or to a plurality of users, the digital media content is packaged by the content issuer 101 in order to protect it from unauthorized access, for example, thereby generating protected digital media content 104, which is transmitted to the user(s).

The content issuer 101 is responsible for delivering the DRM protected digital media content 104. The rights issuer 101 generates a rights object 105 for the protected digital media content 104. A rights object governs how the DRM content may be used. It is for example an XML (Extensible Markup Language) document specifying permissions and constraints related to the DRM protected digital media content 104. The DRM protected digital media content 104 cannot be used without an associated rights object 105 and may only be used according to the permissions and constraints associated with the DRM protected digital media content 104, which permissions and constraints may be included in the rights object 105 by means of so called usage rights. The DRM protected digital media content 104 and the rights object 105 may be requested separately or together and they may be delivered separately or at the same time. The DRM agent 103 embodies a trusted component of a device and is responsible for enforcing permissions and constraints for the DRM protected digital media content 104 and controlling the access to the DRM protected digital media content 104. The DRM protected digital media content 104 can only be accessed with a valid rights object 105.

In the above described way, it is possible to transfer the rights object 105 associated with the DRM protected digital media content 104 to the DRM agent 103. being implemented on a mobile terminal, e.g. on a mobile phone. However, in this way, the rights object 105 is bound to the mobile terminal.

What is therefore needed is a system and method for processing multimedia content in a more flexible manner.

### SUMMARY OF THE INVENTION

The present invention provides a system and method for processing digital media content in a mobile device

According to one aspect of the invention, a method for processing digital media content in a mobile device is provided, wherein the digital media content is protected using digital rights management, wherein a digital rights protection removing unit is assigned to the protected digital media content and which digital rights protection removing unit is used to remove the protection from the protected digital media content. The method includes the steps of receiving a presentation request for presenting stored digital media content, retrieving the digital rights protection removing unit from a memory card of a mobile device or from a User Identity Module unit of a mobile device, verifying that the digital rights protection removing unit allows removal of the protection from the protected digital media content, and removing the protection from the protected digital media content using the digital rights protection removing unit, thereby generating unprotected digital media content for presentation using the mobile device.

In accordance with another aspect of the invention, a method for processing digital media content in a mobile device is provided, wherein the digital media content is protected using digital rights management, wherein a digital rights object is assigned to the protected digital media content and which digital rights object is used to remove the protection from the protected digital media content. The method includes the steps of receiving a presentation request for presenting stored digital media content, retrieving the digital rights object from a User Identity Module memory card of a mobile communication device using a Card Application Toolkit communication protocol, verifying that the digital rights object allows removal of the protection from the protected digital media content, and removing the protection from the protected digital media content using the digital rights object, thereby generating unprotected digital media content for presentation using the mobile device.

In accordance with another aspect of the invention, a system configured to process digital media content in a mobile device is provided, wherein the digital media content is protected using digital rights management, wherein a digital rights protection removing unit is assigned to the protected digital media content and which digital rights protection removing unit is used to remove the protection from the protected digital media content. The system includes means for receiving a presentation request for presenting stored digital media content, means for retrieving the digital rights protection removing unit from a memory card of a mobile device or from a User Identity Module unit of a mobile device, means for verifying that the digital rights protection removing unit allows removal of the protection from the protected digital media content, and means for removing the protection from the protected digital media content using the digital rights protection removing unit, thereby generating unprotected digital media content for presentation using the mobile device.

In accordance with still another aspect of the invention, a system configured to process digital media content in a mobile device is provided, wherein the digital media content is protected using digital rights management, wherein a digital rights protection removing unit is assigned to the protected digital media content and which digital rights protection removing unit is used to remove the protection from the protected digital media content. The system includes a receiver that is configured to receive a presentation request for presenting stored digital media content, a retrieving unit that is configured to retrieve the digital rights protection removing unit from a memory card of a mobile device or from a User Identity Module unit of a mobile device, a verifier that is configured to verify that the digital rights protection removing unit allows removal of the protection from the protected digital media content, and a removing unit that is configured to remove the protection from the protected digital media content using the digital rights protection removing unit, thereby generating unprotected digital media content for presentation using the mobile device.

Furthermore, according to another exemplary embodiment of the invention a mobile device is provided comprising one of the above described systems.

Moreover, according to another aspect of the invention, a computer program product, resident on a computer readable medium, operable to store executable instructions for controlling the processing digital media content in a mobile device, is provided, wherein the digital media content is protected using digital rights management, wherein a digital rights protection removing unit is assigned to the protected digital media content and which digital rights protection removing unit is used to remove the protection from the protected digital media content. The computer. program product has a program code for performing a method including the steps of receiving a presentation request for presenting stored digital media content, retrieving the digital rights protection removing unit from a memory card of a mobile device or from a User Identity Module unit of a mobile device, verifying that the digital rights protection removing unit allows removal of the protection from the protected digital media content, and removing the protection from the protected digital media content using the digital rights protection removing unit, thereby generating unprotected digital media content for presentation using the mobile device.

These and other features of the invention will be better understood in light of the following drawings and detailed description.

### BRIEF DESCRIPTION OF THE DRAWINGS

FIG. 1 illustrates a DRM architecture in accordance with the Open Mobile Alliance Standard version 2.0.

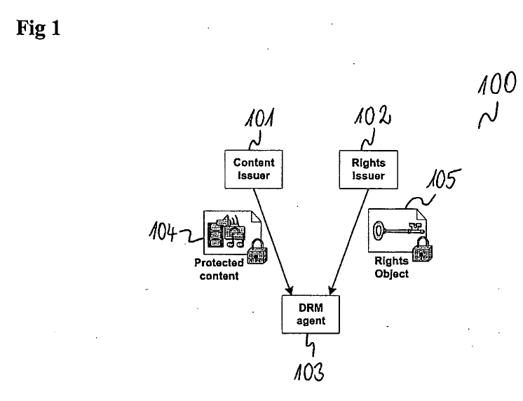

FIG. 2 illustrates a DRM communication system in accordance with an exemplary embodiment of the present invention.

FIG. 3 illustrates a message flow diagram showing the messages that are exchanged in accordance with an exemplary embodiment of the present invention.

FIG. 4 illustrates a UICC showing the storage of the DRM protected digital media content in combination with a digital media content identifier and a DRM indication byte in accordance with an exemplary embodiment of the present invention.

FIG. 5 illustrates a UICC showing the storage of the digital media content rights together with the digital media content in accordance with an exemplary embodiment of the present invention.

FIG. 6 illustrates a UICC showing the storage of the digital media content rights separately from the digital media content in accordance with another exemplary embodiment of the present invention.

### DETAILED DESCRIPTION OF EXEMPLARY EMBODIMENTS

In the drawings, similar elements will be designated with identical reference signs whenever suitable.

According to one embodiment of the invention, the unprotected digital media content is presented to a user using the mobile device. Thus, an easy presentation of protected digital media on the mobile device is achieved using the digital rights protection removing unit from the memory card of the mobile device or the User Identity Module unit of the mobile device,

In accordance with another embodiment of the invention, the presentation request for presenting stored digital media content is received via a radio communication connection. In other words, the presentation request and, if desired, the digital media content, is or are transmitted via a radio communication connection, e.g. by means of a mobile base station, according to UMTS, e.g. by means of a NodeB.

In case the digital media content is transmitted to the mobile device, e.g. via a radio communication connection, the digital media content may be stored in a memory of the mobile device. In an alternative embodiment of the invention, the digital media content may be stored in a memory of the memory card.

In other words, the digital media content may be stored in a memory of the mobile device, e.g. in a memory of the Mobile Equipment, alternatively, the digital media content may be stored in a memory that is provided in the memory card, e.g. in a memory of the Subscriber Identity Module card (when using GSM) or in a memory of the UICC (when using UMTS) or in a memory that is associated with the Replaceable User Information Module (R-UIM) (when using CDMA2000).

A mobile communication device may be used as the mobile device, e.g. a mobile communication device that is configured according a cell based mobile radio communication standard such as a mobile radio communication standard of the second or third generation (e.g. 3^{rd} Generation Partnership Project (3GPP) or 3^{rd} Generation Partnership Project 2 (3GPP2)).

As an example, one of the following mobile radio communication standards may be used:

Universal Mobile Telecommunications System (UMTS),

Code Division Multiple Access 2000 (CDMA2000),

Freedom of Mobile Multimedia Access (FOMA), etc.

Moreover, a User Identity Module memory card may be used as the memory card.

Furthermore, the digital rights protection removing unit may be retrieved from a memory card of a mobile device or from a User Identity Module unit of a mobile device using a mobile device internal communication protocol, e.g. using a memory card communication protocol such as a Card Application Toolkit communication protocol (CAT). When using GSM as the mobile radio communication standard, the digital rights protection removing unit may be retrieved from a memory card of a mobile device using a Subscriber Identity Module Application Toolkit (SAT) communication protocol. When using UMTS as the mobile radio communication standard, the digital rights protection removing unit may be retrieved from a memory card of a mobile device using a UMTS Subscriber Identity Module Application Toolkit (USAT) communication protocol. This means, that according to these aspects of the invention, a memory card internal communication protocol is clearly expanded by a mechanism for storing and retrieving the digital rights protection removing unit in the memory card or from the memory card, respectively. In this context, new messages may be provided for the communication between a processor of the mobile device (e.g. the mobile equipment) and a processor of the memory card.

According to another embodiment of the invention, the digital rights protection removing unit may be retrieved from a memory card of a mobile device using a CDMA Card Application Toolkit communication Protocol.

According to another aspect of the invention, the digital media content may be stored in a memory of the memory card using a mobile device internal communication protocol, e.g. the same communication protocol as described above with regard to storing and retrieving the digital rights protection removing unit.

The digital rights protection removing unit may comprise at least one cryptographic key, namely the at least one cryptographic key that is used for decrypting the protected digital media content, which in this case is cryptographically encrypted. The at least one cryptographic key may be a symmetric cryptographic key when using a symmetric cryptographic algorithm such as the Data Encryption Standard (DES), for example, or an asymmetric cryptographic key when using an asymmetric cryptographic algorithm such as the RSA algorithm. In these examples, the removal of the protection from the protected digital media content comprises decrypting the protected digital media content using the cryptographic key.

Furthermore, the digital rights protection removing unit may comprise at least one licensing rule (also called usage rule) that describes the licensing conditions (or usage conditions) for using the digital media content. In this case, it may be verified that the-at least one licensing rule is fulfilled and the digital media content would only be presented to the user in case the at least one licensing rule is fulfilled.

In case that the digital rights protection removing unit comprises at least one cryptographic key and at least one licensing rule, the digital rights protection removing unit may be the rights object according to the Digital Rights Management standard version 1.0 or 2.0, for example, of the Open Mobile Alliance (OMA). In this case, one aspect of the invention may be seen in the storage of the rights object in the memory card, e.g. in the SIM card or in the UICC of a mobile phone.

In another embodiment of the invention, a digital rights management indication information comprising a plurality of bits is provided, wherein the digital rights management indication information indicates at least one of the following aspects:

if the digital media content is protected according to digital rights management,

if the digital rights protection removing unit is stored in the memory card or in the User Identity Module unit,

if the digital rights protection removing unit is requested.

The digital rights management indication information may be stored in the form of one byte or a plurality of bytes, for example, each byte comprising eight bits, the respective information being coded in the respective bit values.

In another embodiment of the invention, the digital rights management indication information may be stored in a memory of the memory card.

According to one embodiment of the mobile device, a memory card is provided for storing the at least one digital rights protection removing unit. Alternatively, a logic or physical unit (entity) such as the R-UIM according to the CDMA2000 standard, generally a User Identity Module unit, may be provided for storing the at least the digital rights protection removing unit.

As mentioned above, the mobile device may be up as a mobile communication device.

Moreover, the mobile device may have at least one presentation unit for presenting the unprotected digital media content, wherein the at least one presentation unit may be a presentation unit selected from the group of a display and/or a loudspeaker.

The memory card may be a User Identity Module memory card.

Further, a protocol unit for providing a mobile device internal communication protocol for communication between a processor of the mobile device with a processor of the memory card may be provided in the mobile device. The protocol unit may be adapted to provide a Card Application Toolkit communication protocol. As an example, the protocol unit may be adapted to provide a Subscriber Identity Module Application Toolkit communication protocol or a UMTS Subscriber Identity Module Application Toolkit communication protocol.

Furthermore, a decrypting unit for decrypting the protected digital media content using a cryptographic key as the digital rights protection removing unit may be provided in the mobile device and/or in the memory card.

The digital media content may comprise any kind of media data, for example video data, still picture data, audio data, text data, etc.

According to one aspect of the invention, the current USAT mechanisms are clearly expanded so as to allow, according to UMTS, the UICC to store and handle both DRM protected digital media content 104 and its related content rights. Thus, it is now possible to transfer the rights object, for example, to the UICC and store it on the UICC.

According to one embodiment of the invention, a mechanism for UICC based rights management for DRM protected digital media content is defined. Advantages of the mechanisms defined in this embodiment of the invention are:

The UICC, generally speaking the memory card or the User Identity Module unit, will be able to store and handle both DRM protected digital media content and its related digital media content rights.

The DRM protected digital media content and its related digital media content rights will still be available and can be used by the DRM agent on the ME, when the UICC is changed from one ME to another ME.
This means that there will be consistent access to DRM protected digital media contents and the digital media content rights independent of whatever terminal/device a user uses at a certain point of time.
The UICC can clearly be used as an “external” storage space for large DRM protected files plus its digital media content rights if the memory in the terminal is almost full.
The status of the DRM digital media content rights request and transfer can be tracked.

Although the following preferred embodiments are described in connection with the usage of the technologies UICC and CAT, it should be mentioned that the invention is not limited to these technologies. In contrary, the aspects of the invention are valid, for example:
When the technologies USIM and USAT or related technologies (e.g. R-UIM, CDMA Card Application Toolkit (CCAT)) are used to store the digital media content rights.
When any other removable storage module, e.g. the MultiMedia Card (MMC), SD card, etc. is used to store the digital media content rights instead of the UICC/USIM (UMTS Subscriber Identity Module).
When any other storage or secure entity in the mobile device (e.g. the Mobile Equipment according to UMTS) is used to store the digital media content rights instead of the UICC/USIM.

In the following description of the preferred embodiments of the invention, the expression “Separate Delivery” is used only, where the DRM protected content and the rights associated with it are conveyed separately.

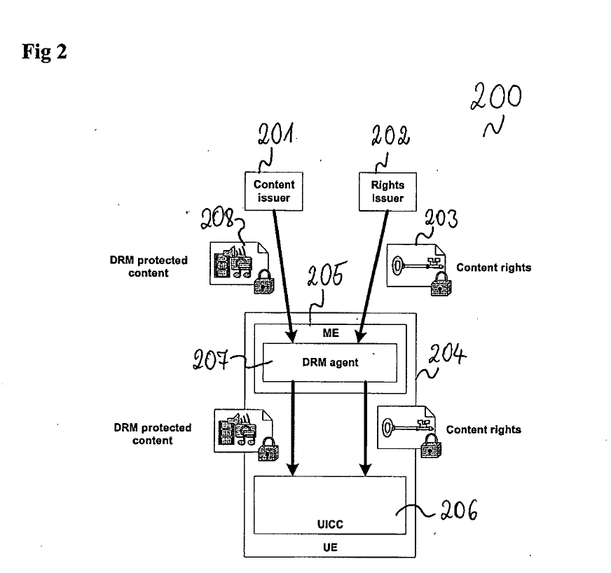

FIG. 2 illustrates a DRM communication system 200 in accordance with an exemplary embodiment of the invention. The DRM communication system 200 and the respective components are configured in accordance to the DRM standard version 2.0 of the OMA. Furthermore, the components are configured to implement the following features that are described in detail.

The DRM communication system 200 comprises a content issuer 201.

The content issuer 201 is an entity or device that delivers digital rights management media content. The OMA DRM standard version 2.0 defines the format of the DRM media content delivered to DRM agents and the way DRM media content can be transported from the content issuer 201 to a DRM agent using different transport mechanisms. The content issuer 201 may perform the actual packaging and thus provide the protection of DRM media content itself, or it may receive pre-packed digital media content from some other source.

The DRM communication system 200 further comprises a rights issuer 202. The rights issuer 202 is an entity or device that assigns permissions and constraints to DRM media content, and generated rights objects 203.

A rights object 203 is an XML document expressing permissions and constraints associated with a piece of DRM media content. Rights objects 203 govern how DRM media content may be used. DRM media content cannot be used without an associated rights object 203 and may only be used as specified by the rights object 203. According to this embodiment of the invention, the rights object 203 includes a cryptographic key which enables the decryption of the encrypted (and thus protected) DRM media content, and usage rules that are assigned to the cryptographic key. The cryptographic key is only valid in case that the requirements according to the assigned usage rules are fulfilled and the usage (e.g. the presentation) of the DRM media content is only possible with the valid cryptographic key used for the decryption of the encrypted DRM media content.

A DRM agent embodies a trusted entity in a mobile device as will be described in more detail below. The trusted entity is responsible for enforcing permissions and constraints associated with DRM media content, controlling access to DRM media content, etc.

The content issuer 201 and the rights issuer 202 are connected with a mobile phone, according to this embodiment of the invention, with a User Equipment (UE) 204 according to UMTS. The UE 204 has a Mobile Equipment (ME) 205 and a Universal Integrated Circuit Card (UICC) 206 that is connected to the ME 205 via a communication interface and is usually located within the housing of the ME 205. The ME 205 has the standard components of a mobile phone such as an antenna, a receiver, a transmitter, an encoder, a decoder, a microprocessor, a memory, etc. Furthermore, the ME 205 has a DRM agent 207 implemented by means of the microprocessor and a corresponding DRM agent computer program.

The ME 205 and the UICC 206 communicate with each other using a memory card communication protocol such as the Card Application Toolkit (CAT) and the respectively available messages. In these embodiments of the invention, new CAT messages are provided in order to store and retrieve the rights object 203 to and from the UICC, respectively, as will be described in more detail below.

In this example the scenario is assumed that the content issuer 201 generates and sends DRM protected media content 208 (e.g. video content, still picture content, audio content, text content, e.g. image, movie, MP3 file, multimedia message or elements therefore, etc.) via a UMTS mobile communication network (not shown) to the UE 206 and in the UE 206 to the DRM agent 207 on the ME 205. The DRM agent 207 receives the DRM protected media content 208 and forwards the DRM protected media content 208 to the UICC 206 using USAT messages and ensures that the DRM protected media content 208 is stored in a memory on the UICC 206.

Separately to this the rights issuer 202 generates media content rights 203 and transmits them via a UMTS mobile communication network (not shown) to the UE 206 and in the UE 206 to the DRM agent on the ME 205. After this the DRM agent 207 receives the media content rights 203 and forwards the media content rights 203 to the UICC 206 and the media content rights 203 are stored in a memory on the UICC 206.

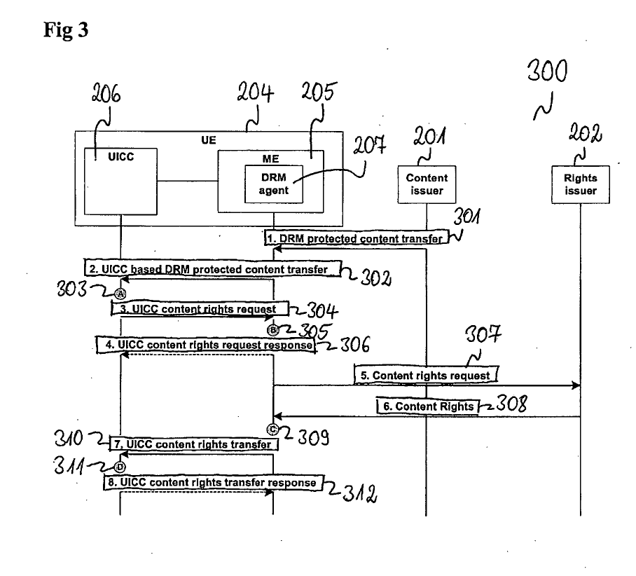

Referring now to FIG. 3, a more detailed description of the transmission of the DRM protected media content 208 and the media content rights 203 is given for the UICC based rights management for DRM protected media content example.

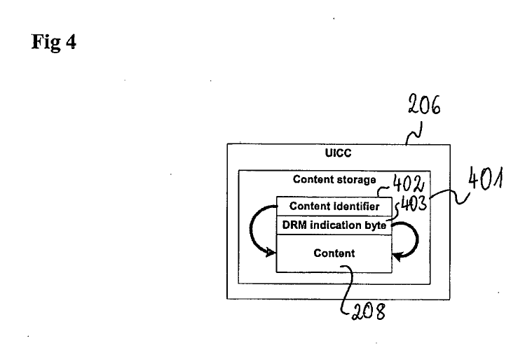

At some point of time the content issuer 201 generates and sends the DRM protected media content 208 to the DRM agent 207 on the ME 207 using a “DRM protected content transfer” message 301 as shown in the message flow diagram 300 in FIG. 3. The “DRM protected content transfer” message 301 includes the DRM protected media content 208. Upon retrieval of DRM protected media content 208 at the DRM agent 207, the DRM agent 207 sends the retrieved DRM protected media content 208 to the UICC 206 using UICC based content transfer mechanisms using CAT mechanisms. According to this embodiment, a “UICC based DRM protected content transfer” message 302 is generated which includes the DRM protected media content 208. After receipt of the “UICC based DRM protected content transfer” message 302, the UICC retrieves the DRM protected media content 208 from the “UICC based DRM protected content transfer” message 302 and stores the DRM protected media content 208 on the USIM together with a content identifier 402 and a DRM indication byte 403 in a memory 401 (also called a content storage) of the UICC 206 (see FIG. 4). This is performed in step 303 in the UICC 206.

The DRM indication byte 403 indicates:

a) If the content is DRM protected or not.

b) If the content rights 203 are available or not.

c) If the content rights 203 are requested or not.

In more detail, the coding of such a DRM indication byte 403 will look as shown in table 1 in accordance with this exemplary embodiment of the invention:

TABLE 1
DRM indication byte 403

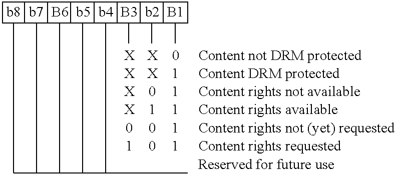

The meaning of the coding of the DRM indication byte is as follows:

a) Bit 1 is 0:
This means that:
   the content stored on the UICCis not DRM protected.

b) Bit 1 is 1:
This means that:
   the content stored on the UICC is DRM protected.

c) Bit 1 is 1 and bit 2 is 0:
This means that:
   the content stored on the UICC is DRM protected;
   the content rights are not available.

d) Bit 1 is 1 and bit 2 is 1:
This means that:
   the content stored on the UICC is DRM protected;
   the content rights are available.

e) Bit 1 is 1, bit 2 is 0 and bit 3 is 0:
This means that:
   the content stored on the UICC is DRM protected;
   the content rights are not available;
   the content rights are not yet requested.

f) Bit 1 is 1, bit 2 is 0 and bit 3 is 1:
This means that:
   the content stored on the UICC is DRM protected;
   the content rights are not available;
   the content rights are requested.

According to this exemplary embodiment, the DRM agent 207 is responsible for updating the DRM indication byte 403.

In this example, after the DRM protected media content 208 is stored on the UICC 206, the DRM agent 207 updates the DRM indication byte 403 by setting it to (see table 2):

TABLE 2
DRM indication byte 403 after the storage of the DRM protected media
content 208 on the UICC 206

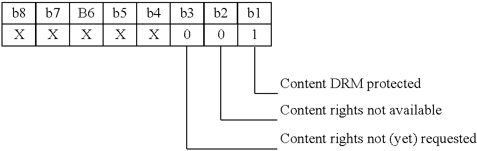

This means that the content stored on the UICC 206 is DRM protected, there are no rights available and the content rights are not (yet) requested. This is also done in step 303 of FIG. 3.

Then, the UICC 206 will request for the content rights 203 associated with the DRM protected media content 208 by generating a CAT command message “UICC content rights request” 304 and sending it to the DRM agent 207 on the ME 205. This command message “UICC content rights request” 304 contains all the information and parameters the DRM agent 207 needs to know to send a content rights request to the rights issuer 202. This means that the command message “UICC content rights request” 304 contains at least the following information/parameters:
The address of the rights issuer 202.
The protocol and/or bearer, which should be used for the content rights 203 transfer.
The content identifier 402.
CAT specific parameters which are needed to transfer a CAT message.

Upon receipt of the CAT command message “UICC content rights request” 304 at the DRM agent 207, the DRM agent 207 performs the following actions in step 305:
The DRM agent 207 generates a “UICC content rights request response” message 306 in response to the receipt of the “UICC content rights request” 304 and sends the “UICC content rights request response” message 306 to the UICC 206. This message will be an OK message when the DRM agent 207 has received the CAT command “UICC content rights request” message 304 correctly and will be an error message when the DRM agent 207 did not receive the CAT command message “UICC content rights request” 304 correctly. In this example, it is assumed that the DRM agent 207 receives the CAT command message “UICC content rights request” 304 correctly, so the DRM agent 207 sends an OK message back to the UICC 206.
Based on the information in the “UICC content request” 304, the DRM agent 207 generates a “UICC content rights request” message 307 and sends it to the rights issuer 202.

The DRM agent 207 updates the DRM indication byte 403; the DRM agent 207 sets bit 3 of the DRM indication byte 403 to the value 1 (see table 3); this bit combination of the DRM indication byte 403 means that the content stored on the UICC 206 is DRM protected, there are no rights available and the content rights 203 are requested.

TABLE 3
DRM indication byte 403 after the content fights 203 are requested

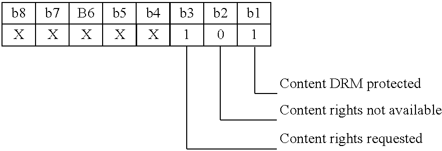

When the DRM agent 207 receives the CAT command message “UICC content rights request” 304, the DRM agent 207 will thus compose a content rights request message 307 using the information/parameters in the CAT command message “UICC content rights request” 304 and sends the content rights request message 307 to the rights issuer 202. After reception of the above mentioned message 307 at the rights issuer 202, the rights issuer 202 searches for the belonging content rights 203 and sends these content rights back to the DRM agent 207 in a content rights message 308.

After reception of the content rights message 308 from the rights issuer 202, the DRM agent 207 composes the CAT command message “UICC content rights transfer” 310 and sends this CAT command to the UICC 206 (step 309). The CAT command message “UICC content rights transfer” 310 contains at least the following information/parameters:
The content rights 203.
The content identifier 403.
The CAT specific parameters which are needed to transfer a CAT command to the UICC 206.

Upon reception of the CAT command message “UICC content rights transfer” 310 at the UICC 206, the UICC 206 performs the following actions (step 311):

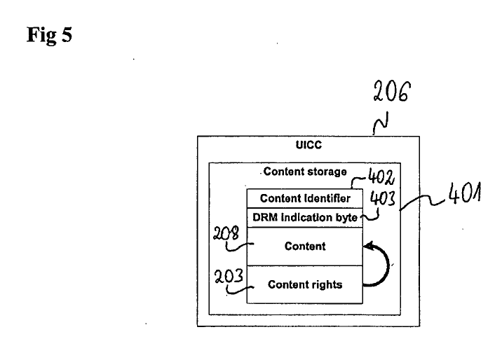

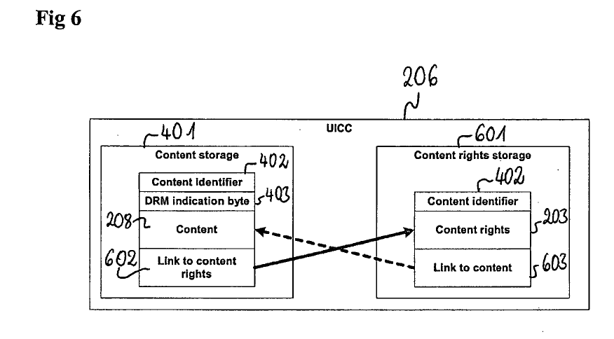

a) The content rights 203 are stored on the UICC 206.
There are two different ways to store the content rights on the UICC 206:
1. The content rights 203 are stored together with the content (see FIG. 5):
   In this case, the content rights 203 are stored together with the related DRM protected media content 208, content identifier 402 and the DRM indication byte 403 within one file or group of files dedicated for the content storage 401.
2. The content rights 203 are stored separately from the content (see FIG. 6):
   In this case, the content rights 203 are stored separately from the DRM protected media content 208 in a content rights storage 601. The DRM protected media content 208 is stored in a file or file group dedicated for the content storage 401. In here, the DRM protected media content 208 is stored together with the content identifier 402, the DRM indication byte 403 and a link 602 to the content rights 203. The content rights 203 are stored in a file or file group dedicated for the content rights 203. The content rights 203 are stored together with the content identifier 402 and a link 603 to the related DRM protected media content 208. The content rights 203 are stored in the content rights storage 601 and the DRM protected media content 208 is stored in the content storage 401.

b) Further, the DRM indication byte 403 is updated by the DRM agent 207 (see table 4). Bit 2 is set to the value 1. This means that the content stored on the UICC 206 is DRM protected, the content rights 203 are requested, and the content rights 203 are available.

TABLE 4
DRM indication byte 403 after the storage of the content rights 203 on
the UICC 206

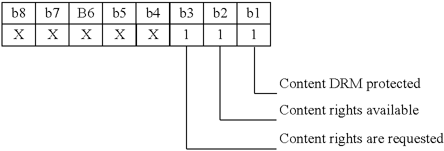

Finally, the UICC 206 responses with a “UICC content rights transfer response” message 312 that it generates and that it sends to the DRM agent 207 on the ME 205. This “UICC content rights transfer response” message 312 will be an OK message when the UICC 206 received the CAT command message “UICC content rights transfer” 310 with the content rights 203 correctly and will be an error message when the UICC 206 did not receive the CAT command message “UICC content rights transfer” 310 with the content rights 203 correctly. In this example, it is assumed that the UICC 206 received the content rights 203 with the CAT command message “UICC content rights” 310 correctly, so the UICC 206 generates and sends an OK message back to the UICC 206 as the “UICC content rights transfer response” message 312.

When the user of the UE 204 wants to listen to a piece of music that is included in the DRM protected media content 208, the user inputs a corresponding command into the UE 204, e.g. by means of the keys of the ME 205. The ME 205 together with the UICC 206 then determines as to whether the user is allowed to get the DRM protected media content 208 presented according to the content rights 203 associated with the DRM protected media content 208. For this purpose, the ME 205 or the UICC 206 retrieves the stored content rights 203 and determines as to whether the user request fulfills the DRM usage rules according to the content rights 203.

If the requirements of the content rights 203 are fulfilled, then the protection of the DRM protected media content 208 will be removed, e.g. the DRM protected media content 208 will be decrypted using the cryptographic key of the content rights 203. The decrypted media content will then be presented to the user, e.g. the requested piece of music will be played to the user by means of the loudspeaker of the ME 205.

If the requirements of the content rights 203 are not fulfilled, then an error message is generated and the user is informed about the invalid request and that the desired DRM protected media content 208 will not be presented, e.g. the requested piece of music will not be played.

In the following, some aspects of the invention will be summarized.

A UICC based rights management mechanism for DRM protected content is provided.

Upon the retrieval of DRM protected content at the DRM agent the following actions are executed:

a) The DRM protected media content 208 is transferred from the DRM agent 207 to the UICC 206.

b) The DRM protected media content 208 is stored on the UICC 206 together with the content identifier 402 and a DRM indication byte 403, wherein the DRM indication byte 403 indicates:
If the content is DRM protected or not.
If the corresponding content rights 203 are available in the UICC 206 or not.
If the content rights 203 are requested or not.

c) The DRM agent 207 updates the DRM indication byte 403.

d) The DRM indication byte 403 is updated, wherein the DRM agent 207 sets the DRM indication byte 403 to:
“Content DRM protected”;
“Content rights not available in the UICC”;
“Content rights not (yet) requested”.

e) The UICC 206 composes a new CAT command message “UICC content rights request” and sends this message to the DRM agent 207 on the ME 205; the CAT command message “UICC content rights request” contains all the information and parameters the DRM agent 207 needs to know to send a content rights request to the rights issuer 202; in this embodiment, the CAT command “UICC content rights request contains the following parameters/information:
The address of the rights issuer 202.
Which protocol and/or bearer should be used for the content rights transfer.
The content identifier 420.
CAT specific parameters.

f) The DRM agent 207 knows how to interpret the CAT command message “UICC content rights request” and with the information/parameters in this CAT command message, the DRM agent 207 composes a content rights request message.

g) The DRM agent 207 sends the content rights request message to the rights issuer 202.

h) The DRM agent 207 updates the DRM indication byte 403, wherein the DRM agent 207 sets the DRM indication byte 403 to:
“Content DRM protected”;
“Content rights not available in the UICC”;
“Content rights requested”.

i) Upon reception of the above mentioned message, the rights issuer 202 sends the requested content rights 203 associated with the DRM protected media content 208 to the DRM agent 207.

j) Upon the retrieval of the content rights 203 at the DRM agent 207, the DRM agent 207 composes a new CAT message “UICC content rights transfer”. In this embodiment, the CAT message “UICC content rights transfer” contains the following information/parameters:
The content rights 203.
The content identifier 402.
CAT specific parameters.

k) The DRM agent 207 sends the content rights 203 to the UICC 206 by using the CAT command “UICC content rights transfer”.

l) Upon reception of the CAT message “UICC content rights transfer message”, the following actions are executed:
The content rights 203 are stored on the UICC 206; the content rights 203 can be stored in two ways:
   The content rights 203 can be stored together with the content.
   The content rights 203 can be stored separately from the content.

m) The DRM agent 207 updates the DRM indication byte 403, wherein the DRM agent 207 sets the DRM indication byte 403 to:
“Content DRM protected”;
“Content rights not available in the UICC”;
“Content rights not (yet) requested.

The described processes and mechanisms may be implemented in hardware, software, firmware or a combination of these implementations as appropriate. In addition, some or all of the described processes may be implemented as computer readable instruction code resident on a computer readable medium (removable disk, volatile or non-volatile memory, embedded processors, etc.), the instruction code operable to program a computer of other such programmable device to carry out the intended functions.

The foregoing description has been presented for purposes of illustration and description. It is not intended to be exhaustive or to limit the invention to the precise form disclosed, and obviously many modifications and variations are possible in light of the disclosed teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

List of Reference Symbols

100 DRM architecture

101 content issuer

102 rights issuer

103 DRM agent

104 protected digital media content

105 rights object

200 DRM communication system

201 content issuer

202 rights issuer

203 rights object

204 User Equipment

205 Mobile Equipment

206 Universal Integrated Circuit Card

207 DRM agent

208 DRM protected media content

303 message flow diagram

301 “DRM protected content transfer” message

302 “UICC based DRM protected content transfer” message

303 method step

304 “UICC content rights request” message

305 method step

306 “UICC content rights request response” message

307 “UICC content rights request” message

308 content rights message

309 method step

310 “UICC content rights transfer” message

311 method step

312 “UICC content rights transfer response” message

401 memory

402 content identifier

403 DRM indication byte

601 content rights storage

602 link to content rights

603 link to related DRM protected media content

What is claimed is:

1. A method for processing digital media content in a mobile device, wherein the digital media content is protected using digital rights management, wherein a digital rights protection removing unit is assigned to the protected digital media content and which digital rights protection removing unit is used to remove the protection from the protected digital media content, comprising the steps of:
receiving a presentation request for presenting stored digital media content;
retrieving the digital rights protection removing unit from a memory card of a mobile device or from a User Identity Module unit of a mobile device;
verifying that the digital rights protection removing unit allows removal of the protection from the protected digital media content; and
removing the protection from the protected digital media content using the digital rights protection removing unit, thereby generating unprotected digital media content for presentation using the mobile device.

2. The method of claim 1, further comprising the step of presenting the unprotected digital media content using the mobile device.

3. The method of claim 1, further comprising the step of receiving the presentation request for presenting stored digital media content via a radio communication connection.

4. The method of claim 1, further comprising the step of receiving the digital media content.

5. The method of claim 1, further comprising the step of storing the digital media content in a memory of the mobile device.

6. The method of claim 1, further comprising the step of storing the digital media content in a memory of the memory card.

7. The method of claim 1, further comprising the step of using a mobile communication device as the mobile device.

8. The method of claim 7, further comprising the step of using a User Identity Module memory card as the memory card.

9. The method of claim 1, further comprising retrieving the digital rights protection removing unit from a memory card of a mobile device or from a User Identity Module unit of a mobile device using a mobile device internal communication protocol.

10. The method of claim 9, further comprising retrieving the digital rights protection removing unit from a memory card of a mobile device using a memory card communication protocol.

11. The method of claim 10, further comprising retrieving the digital rights protection removing unit from a memory card of a mobile device using a Card Application Toolkit communication protocol.

12. The method of claim 11, further comprising retrieving the digital rights protection removing unit from a memory card of a mobile device using a Subscriber Identity Module Application Toolkit communication protocol or a UMTS Subscriber Identity Module Application Toolkit communication protocol.

13. The method of claim 11, further comprising retrieving the digital rights protection removing unit from a memory card of a mobile device using a CDMA Card Application Toolkit communication Protocol.

14. The method of claim 6, further comprising storing the digital media content in a memory of the memory card using a mobile device internal communication protocol.

15. The method of claim 14, further comprising storing the digital media content in a memory of the memory card using a memory card communication protocol.

16. The method of claim 15, further comprising storing the digital media content in a memory of the memory card using a Card Application Toolkit communication protocol.

17. The method of claim 16, further comprising storing the digital media content in a memory of the memory card using a Subscriber Identity Module Application Toolkit communication protocol or a UMTS Subscriber Identity Module Application Toolkit communication protocol.

18. The method of claim 16, further comprising storing the digital media content in a memory of the memory card using a CDMA Card Application Toolkit communication protocol.

19. The method of claim 1,
wherein the digital rights protection removing unit comprises a cryptographic key, and
wherein the removal of the protection from the protected digital media content comprises the step of decrypting the protected digital media content using the cryptographic key.

20. The method of claim 1,
wherein the digital rights protection removing unit comprises at least one licensing rule that describes the licensing conditions for using the digital media content, and
wherein it is verified that the at least one licensing rule is fulfilled.

21. The method of claim 1, further comprising the step of providing a digital rights management indication information comprising a plurality of bits, wherein the digital rights management indication information indicates at least one of the following aspects:
if the digital media content is protected according to digital rights management,
if the digital rights protection removing unit is stored in the memory card or in the User Identity Module unit, and/or
if the digital rights protection removing unit is requested.

22. The method of claim 21, further comprising the step of storing the digital rights management indication information in a memory of the memory card.

23. A method for processing digital media content in a mobile device, wherein the digital media content is protected using digital rights management, wherein a digital rights object is assigned to the protected digital media content and which digital rights object is used to remove the protection from the protected digital media content, comprising the steps of:
receiving a presentation request for presenting stored digital media content;
retrieving the digital rights object from a User Identity Module memory card of a mobile communication device using a Card Application Toolkit communication protocol;
verifying that the digital rights object allows removal of the protection from the protected digital media content; and
removing the protection from the protected digital media content using the digital rights object, thereby generating unprotected digital media content for presentation using the mobile device.

24. A system configured to process digital media content in a mobile device, wherein the digital media content is protected using digital rights management, wherein a digital rights protection removing unit is assigned to the protected digital media content and which digital rights protection removing unit is used to remove the protection from the protected digital media content, comprising:
means for receiving a presentation request for presenting stored digital media content;
means for retrieving the digital rights protection removing unit from a memory card of a mobile device or from a User Identity Module unit of a mobile device;
means for verifying that the digital rights protection removing unit allows removal of the protection from the protected digital media content; and
means for removing the protection from the protected digital media content using the digital rights protection removing unit, thereby generating unprotected digital media content for presentation using the mobile device.

25. A system configured to process digital media content in a mobile device, wherein the digital media content is protected using digital rights management, wherein a digital rights protection removing unit is assigned to the protected digital media content and which digital rights protection removing unit is used to remove the protection from the protected digital media content, comprising:
a receiver that is configured to receive a presentation request for presenting stored digital media content;
a retrieving unit that is configured to retrieve the digital rights protection removing unit from a memory card of a mobile device or from a User Identity Module unit of a mobile device;
a verifier that is configured to verify that the digital rights protection removing unit allows removal of the protection from the protected digital media content; and
a removing unit that is configured to remove the protection from the protected digital media content using the digital rights protection removing unit, thereby generating unprotected digital media content for presentation using the mobile device.

26. A mobile device comprising the system of claim 24.

27. A mobile device comprising the system of claim 25.

28. The mobile device of claim 27, further comprising a memory card for storing the at least the digital rights protection removing unit.

29. The mobile device of claim 27, further comprising a User Identity Module unit for storing the at least the digital rights protection removing unit.

30. The mobile device of claim 27, being set up as a mobile communication device.

31. The mobile device of claim 30, further comprising at least one presentation unit for presenting the unprotected digital media content.

32. The mobile device of claim 31, wherein the at least one presentation unit is a presentation unit selected from the group of a display and/or a loudspeaker.

33. The mobile device of claim 30, wherein the memory card is a User Identity Module memory card.

34. The mobile device of claim 30, further comprising a protocol unit that is adapted to provide a mobile device internal communication protocol for communication between a processor of the mobile device with a processor of the memory card.

35. The mobile device of claim 34, wherein the protocol unit is adapted to provide a Card Application Toolkit communication protocol.

36. The mobile device of claim 35, wherein the protocol unit is adapted to provide a Subscriber Identity Module Application Toolkit communication protocol or a UMTS Subscriber Identity Module Application Toolkit communication protocol.

37. The mobile device of claim 35, wherein the protocol unit is adapted to provide a CDMA Card Application Toolkit communication protocol.

38. The mobile device of claim 30, further comprising a decrypting unit for decrypting the protected digital media content using a cryptographic key as the digital rights protection removing unit.

39. A computer program product, resident on a computer readable medium, operable to store executable instructions for controlling the processing digital media content in a mobile device, wherein the digital media content is protected using digital rights management, wherein a digital rights protection removing unit is assigned to the protected digital media content and which digital rights protection removing unit is used to remove the protection from the protected digital media content, the computer program product having a program code for performing a method comprising the steps of:
receiving a presentation request for presenting stored digital media content;
retrieving the digital rights protection removing unit from a memory card of a mobile device or from a User Identity Module unit of a mobile device;
verifying that the digital rights protection removing unit allows removal of the protection from the protected digital media content; and
removing the protection from the protected digital media content using the digital rights protection removing unit, thereby generating unprotected digital media content for presentation using the mobile device.
